(19) United States
(12) Patent Application Publication
(10) Pub. No.: US 2018/0369739 A1
(43) Pub. Date: Dec. 27, 2018

(54) H2 PSA WITH MODIFICATION OF THE FEED GAS FLOW

(71) Applicant: L'Air Liquide, Société Anonyme pour I'Etude et I'Exploitation des Procédés Georges Claude, Paris (FR)

(72) Inventors: Louis TOULEMONDE, Douai (FR); Christian MONEREAU, Montpellier (FR)

(21) Appl. No.: 16/069,903

(22) PCT Filed: Dec. 15, 2016
(86) PCT No.: PCT/FR2016/053467

§ 371 Date: Jul. 13, 2018

(30) Foreign Application Priority Data
Jan. 13, 2016 (FR) 1650261

(51) Int. Cl. B01D 53/047; C01B 3/56

(52) U.S. Cl. CPC B01D 53/047; C01B 3/56; B01D 2253/102; B01D 2253/108; B01D 2257/7025; B01D 2257/102; B01D 2257/502; B01D 2257/504; B01D 2256/16

(57) ABSTRACT

A process for the production of a gas stream with a hydrogen concentration equal to or greater than 99.9% utilizing a pressure swing adsorption unit with a main gas stream having at least 70 mol % of hydrogen, wherein a secondary stream, representing less than 20% of the molar flow rate of the main gas stream and having a hydrogen content of less than 25 mol %, is introduced into the main gas stream upstream of the PSA is presented.

### CROSS REFERENCE TO RELATED APPLICATIONS

This application is a 371 of International Patent Application No. PCT/FR2016/053467, filed Dec. 15, 2016, which claims priority to French Patent Application No. 1650261, filed Jan. 13, 2016, the entire contents of which are incorporated herein by reference.

### BACKGROUND

The present invention relates to a process for separation by pressure swing adsorption (PSA).

Although being able to be of general scope, the present invention is limited here to the production of hydrogen, and more specifically to the production of hydrogen of high purity, that is to say having an H2 purity of greater than or equal to 99.9 mol %.

Generally, a PSA unit is composed of several adsorbers operating in a manner offset in time, each adsorber being subjected to one and the same operating cycle. The offsetting between each adsorber is known as phase time and is equal to the cycle time divided by the adsorber number.

During the operating cycle, each adsorber alternates overall between an adsorption stage at substantially high pressure and regeneration stages at substantially low pressure.

During the adsorption stage at substantially high pressure, the most adsorbable constituents present in the feedstock gas become preferentially fixed to the adsorbents, allowing the less adsorbable components to pass. There is thus obtained, at the adsorber top, a first product relatively pure in constituents having a low adsorption capacity.

During the regeneration stages at substantially low pressure, the constituents previously adsorbed are released and entrained toward the bottom of the adsorber, that is to say side of the inlet of the gas to be treated. This entrainment is generally carried out using a stage of countercurrentwise depressurization (in the reverse direction to that of the gas to be treated during the adsorption) and/or a stage of elution by a gas rich in constituents having a low adsorption capacity, itself carried out countercurrentwise. There is thus obtained, at the adsorber bottom, a second product relatively rich in constituents having a high adsorption capacity.

It should be noted here that, when reference is made to adsorbability or adsorption capacity of a constituent, this is always with respect to a given adsorbent. Thus, depending on the constituents which it is desired to separate, choices of different adsorbents may have to be made.

Take the example of a PSA unit which produces hydrogen of very high purity from a synthesis gas, itself already rich in hydrogen, but from which it is desired to extract certain impurities in a very high amount, such as N₂, CO, CH₄ and CO₂. In order to preferentially halt the CO₂, a bed of activated carbon is installed at the inlet of the adsorber, which is covered with a bed of molecular sieve in order to halt the CO and the N₂, these last two constituents being weakly adsorbed on the activated carbon. The CH₄, for its part, is adsorbed both on the activated carbon and on the molecular sieve. At the adsorber top, it is thus possible to obtain a gas rich in hydrogen, the contents of which can range up to more than 99.999%. At the adsorber bottom, there exits the waste product which contains virtually all of the impurities (CO₂, CH₄, CO, N₂, and the like) and the H₂ which is not recovered and is thus lost for the production.

A PSA is generally characterized by three performance criteria: the purity of the top product or of the tail product, the yield of most or least adsorbable constituents, depending on the application envisaged, and the productivity. The productivity corresponds to the amount of feedstock gas which an adsorber is capable of treating per unit of volume of adsorbents under the conditions selected. At a fixed flow of feedstock gas, the volume of adsorbents to be installed per adsorber is thus directly related to the productivity, and also to the phase time. In practice, the purity of the top product or of the tail product is generally fixed, and it is generally desired to optimize the performance pair: yield and productivity.

This is particularly true in the case of the production of hydrogen, the purity of which is fixed by the downstream user processes or by the purity of the network into which it is introduced.

It has been seen that, in a PSA unit, the adsorbents are chosen in order to preferentially fix the most adsorbable constituents, which will be found in the “bottom product”, at low pressure, with respect to the weakly adsorbable constituents, which will form the “top product” at high pressure. However, a certain amount of weakly adsorbable constituents is inevitably adsorbed at the same time as the most adsorbable constituents during the adsorption stages at high pressure. Reference is then made to coadsorption phenomenon, that is to say that an adsorbent generally does not exhibit an infinite selectivity with regard to a constituent but will simultaneously stop several of them in different proportions. Weakly adsorbable gases are also found in the free spaces which constitute the dead spaces at the adsorber bottom and top, the free spaces being inter- or intragranular.

Without specific “precautions”, these amounts of weakly adsorbable constituents present in the dead spaces and the beds of adsorbents at the beginning of regeneration stages would for the most part be lost in the tail product because of their low adsorption capacity. This would have the effect of reducing the yield of weakly adsorbable constituents of the top product.

In the state of the art, in order to minimize the losses in yield due to the excessive presence of weakly adsorbable constituents in the adsorbers at the start of regeneration stages, numerous cocurrentwise depressurization stages are added to the operating cycle of the PSA.

These stages are generally inserted between the adsorption stage at high pressure and the countercurrentwise depressurization stages and/or the elution stage at low pressure. They make it possible to extract, from the adsorber, a gas which is relatively rich in weakly adsorbable constituents, which is subsequently made use of economically at another time in the operating cycle. In this way, the amount of weakly adsorbable constituents lost in the waste product tends to be reduced.

There are mainly found two types of cocurrentwise depressurization stages which make it possible to recover or to use, wisely, the least adsorbable constituents: the equilibrating stage and the feed/elution stage.

For the equilibrating stage, the gas extracted during the cocurrentwise depressurization, which is relatively rich in weakly adsorbable constituents, feeds a countercurrentwise repressurization stage located downstream of the regeneration stages proper (cocurrent decompression, elution), until there is complete or partial equilibrating of the pressures between the two adsorbers. During this stage, there is thus no loss of weakly adsorbable constituents outside the unit but a transfer from one adsorber to another. A conventional PSA cycle generally contains one to several equilibrating stages in order to maximize the amounts of economically recoverable constituents which it is desired to recover.

While, initially, the first H₂ PSAs comprised just one equilibrating stage, which already made it possible to recover overall from 70% to 75% of the hydrogen present in their feed, the current large PSAs, that is to say producing at least 50 000 Sm³/h of H₂, comprise 3 or 4 equilibratings and make it possible to obtain extraction yields of close to 90%.

For the feed/elution stage, the gas extracted, itself also relatively rich in weakly adsorbable constituents, feeds one/several elution stages at low pressure. In this way, the weakly adsorbable constituents are made use of economically by using them for the regeneration of the adsorbent beds. In practice, they facilitate the desorption of the impurities by lowering their partial pressure in the circulating gas. It should be noted that, in this case, there is all the same loss of a portion of the weakly adsorbable constituents in the tail product but to operate in this way avoids having to use production gas and thus contributes to a high yield being obtained.

However, this change toward a cycle having an increasing number of equilibrating stages has its limits, both in terms of additional capital cost and in efficiency.

More equilibratings means first more additional items of equipment to be installed. For example, in order to change from a cycle having two equilibrating stages to a cycle having four equilibrating stages, with identical adsorption times and with identical purge times, it is observed that it is generally necessary to install two additional adsorbers, and also an equilibrating gas collector dedicated to the two new equilibrating stages, plus all the associated valves. This has the consequence of already substantially increasing the capital cost of the PSA.

However, the main effect associated with the increase in the equilibrating number is the fall in the productivity of the PSA. This decrease in the productivity is due to two additional causes. It may be noted, first, that the increase in the amounts of gas rich in weakly adsorbable constituents, in this instance in hydrogen, recovered during the equilibrating stages, takes place to the detriment of the amounts of gas feeding the elution stage at low pressure. Thus, as the number of equilibrating stages increases, the quality of the regeneration deteriorates, that is to say that more and more impurities will be left in the adsorbers, which has the immediate effect of reducing the amount of feed gas which can be treated per adsorption phase.

With a fixed feedstock gas flow rate and with a fixed phase time, this will have the consequence of substantially increasing the volume of the adsorbers and thus the capital cost of the PSA.

It will be noted that, beyond a certain number of equilibrating stages, when the amounts of gas rich in weakly adsorbable constituents, in hydrogen in the case of an H₂ PSA, feeding the elution stage become too low, the quality of the regeneration in the end becomes insufficient and the yield of the PSA begins to decrease. An “elution ratio” is generally defined which is the amount in true cubic meters of feed/elution gas divided by the amount of feedstock gas, and for which it is estimated that the minimum generally lies around 1.1 or 1.2, in particular in the case of H₂ PSA.

The other negative effect of the increase in the number of equilibratings is that, during cocurrentwise depressurizations, the impurities have a tendency to be desorbed under the effect of the fall in pressure and to be entrained by the circulating gas stream toward the top of the adsorber, that is to say toward the production side. As it is desired to really recover the least adsorbable gas, in this instance the hydrogen, but not the impurities, it is advisable to additionally add a volume of adsorbent in order to retain these undesirable constituents in the adsorber in depressurization.

These combined effects can be very important and can result eventually in installing, in a unit which is very effective in terms of extraction yield, several times the volume necessary for a PSA which is less effective but with just one equilibrating.

In practice, in order to adjust as best as possible the amount of gas rich in weakly adsorbable constituents which is exchanged between adsorbers, during the equilibrating stages, it is possible to interrupt certain equilibrating stages before there is complete equilibrating of the pressures between the adsorber in cocurrentwise depressurization and the adsorber in countercurrentwise repressurization. Reference is then made to incomplete equilibrating. By this means, it is possible to more precisely adjust the performance qualities of the PSA, namely yield and productivity. It is consequently possible to define the true theoretical equilibrating number, calculated from the whole number of equilibrating stages, multiplied by the ratio of the amounts of gas actually exchanged between adsorbers to the maximum amounts which it would be possible to exchange in the case of complete equilibratings. Thus, an H₂ PSA can have collectors and valves for carrying out 4 successive equilibratings but, in practice, can carry out only the equivalent of 3.4 or 3.7.

A person skilled in the art, having rapidly become aware of the major additional capital cost to be paid in compensation for the gain in efficiency which more numerous equilibratings would provide, has looked for other solutions, sometimes for very specific applications of the H₂ PSAs.

One of these solutions consists in recycling a portion of the waste product. This solution is particularly advantageous, provided that the feedstock gas of the H₂ PSA is very rich in hydrogen. For a feed gas containing, for example, 90 mol % of hydrogen, the waste product can contain, for its part, more than 70 mol % of hydrogen. To reintroduce a fraction of this waste product into the feed of the PSA will make it possible to substantially increase the production of hydrogen and thus the extraction yield with respect to the main feedstock gas, for a relatively small increase in the volume of adsorbent. U.S. Pat. No. 6,315,818 describes a solution of this type. When the waste product is relatively poor in hydrogen, it has been proposed to treat the latter in a permeation unit and to use the fraction rich in hydrogen resulting from this unit as makeup gas with the same result as in the preceding case. Unless favorably configured, these solutions require a compression unit in order to bring the stream rich in hydrogen which it is desired to recycle back up to the high pressure of the PSA. They are thus also expensive in capital cost and in energy.

Another solution family consists in driving off the least adsorbable gases from the adsorber by immediately introducing, after the feedstock gas, a gas very rich in highly adsorbable constituents. The least adsorbable gases are then desorbed and pushed towards the top end, making it possible to thus produce an additional amount of these gases. This stage is generally known as “rinse” stage. It is commonly used in PSAs, the main production of which is the most adsorbable constituent. By removing the lightest constituents from the adsorber, it makes it possible to obtain, by decompression, a fluid having a greater purity. The adsorbable gas used for this rinse stage is generally gas produced at low pressure. While this technique is used in particular for CO₂ PSAs and some CO PSAs, alternative forms could be provided for H₂ PSAs.

In particular, provision has been made to use, as rinse gas, nitrogen in the case where the hydrogen is intended for the synthesis of ammonia, the nitrogen which is then re-encountered in the hydrogen not being troublesome, or natural gas, which is subsequently re-encountered in the waste product and is used as fuel gas.

This solution, which consists in additionally adding a rinse stage after the adsorption stages, complicates the cycle of the PSA and results in generally additionally adding an adsorber. The amount of adsorbable gas to be injected is relatively high if it is desired to drive off the hydrogen from an appreciable part of the volume of adsorbent.

FR 2 836 060, for its part, cited by way of illustration of the processes which can be used in the case of H₂ PSAs, describes a fairly complex cycle which, in some alternative forms, combines both a partial recycling of the waste product and a contribution of secondary gas containing hydrogen, it being possible for the main feedstock gas and the two additional fractions to be successively introduced into the unit as a function of their respective hydrogen contents, the poorer in H₂ last, thus creating a rinse effect.

Here again, it is possible to obtain high extraction yields of hydrogen when reckoning with respect to the main feed alone but this is at the expense of a high complexity which restricts such a solution to specific cases.

### DESCRIPTION OF PREFERRED EMBODIMENTS

The aim of the present invention is thus in this instance to present a process which makes it possible to increase the hydrogen extraction yield of an H₂ PSA or, with fixed production, to increase its productivity by deploying only very simple and relatively inexpensive means.

A solution of the present invention is a process for the production of a gas stream exhibiting a hydrogen concentration equal to or greater than 99.9% by means of a pressure swing adsorption (PSA) unit starting from a main gas stream comprising at least 70 mol % of hydrogen, characterized in that a secondary stream, representing less than 20% of the molar flow rate of the main gas stream and having a hydrogen content of less than 25 mol %, is introduced into this main gas stream upstream of the PSA.

The field of the invention is limited to the cases where the feed gas of the PSA is rich in hydrogen and where it is desired to produce pure hydrogen. These two elements, taken together, mean that, at the end of the adsorption stage, a significant amount of hydrogen remains in the adsorber, whether it is the hydrogen present in the inter- and intraparticulate spaces of the zones saturated by the various impurities or the hydrogen present in the top zone of the adsorber, in particular in the frontal zone. This is because, in view of the desired purity, it is impossible to cause the impurities to progress too deeply into the adsorber and the final zone of adsorbent contains only virtually pure hydrogen.

The aim desired in this instance is only to recover a fraction of the hydrogen present, putting in terms of extraction yield, to gain from 0.5% to 2%, without, however, substantially modifying the design of the PSA carried out on the gas mixture alone which constitutes its main feed. The additional stream which will be injected into the main feedstock gas must thus constitute only a small fraction of the latter in terms of flow rate. Likewise, the aim desired is not to treat more hydrogen but to introduce constituents which are sufficiently adsorbable to displace the hydrogen present in the adsorbent during the adsorption stage. In order for this to be effective but not to result in the necessary volume of adsorbent being increased, it is advisable for these constituents not to be diluted by hydrogen which would be present in the secondary stream and thus for the latter to contain less than 25 mol % thereof and if possible much less.

The difference between what is provided in this instance and the processes employing a recycling of the waste product, preferentially of the fraction richest in hydrogen, or the addition to the main mixture of a second feed rich in hydrogen should be noted. In the latter cases, the aim desired is to increase the amount of hydrogen in the feed even if it means substantially increasing the flow rate of gas to be treated, in order to produce more with a virtually constant extraction yield.

According to the principle of the invention, it is not desired to have more hydrogen in the feed of the PSA but an additional amount of impurities well chosen in order to recover slightly more hydrogen.

In its operating mode, the invention more closely resembles the PSA processes employing a rinse stage. It should be remembered that, in the rinse case, for a PSA of the H₂ PSA type, once the adsorption stage is complete, a gas which is more adsorbable than the feed gas is introduced at high pressure, which gas will virtually drive off all of the inter- and intraparticulate hydrogen. In order to have a sufficient effect, it is advisable, in this case, to introduce an appreciable amount of rinse gas, generally more than 30%, in order for the additional impurities to saturate, for example, half of the adsorbent. Such a process results, as has been said, in complicating the PSA and in enlarging the size of the adsorbers as the moderately adsorbable impurities, driven off at the same time as the hydrogen by the rinse gas, have to be adsorbed further downstream in the adsorber. This process is very rarely used in this form in H₂ PSAs but it is more frequent than, when two—or more—feeds rich in hydrogen are available, they are successively introduced into the adsorbers, from the richer to the poorer in hydrogen, instead of mixing them. This feed sequence obviously complicates the management of the PSA.

By comparison, in the context of the invention, only one feed gas is treated in the PSA, which feed gas is itself obtained by adding, to the main mixture rich in hydrogen, a small flow rate of a gas poor in hydrogen and containing appropriate impurities. In that way, the cycle does not need to be modified, and more stages or items of equipment, such as collectors or valves, do not need to be added. In return, the gains, with regard to the yield, are at best only a few points, substantially less than what recycling or additional equilibratings may contribute. Economically, the solution provided is, on the other hand, very advantageous as the gain, substantial in the case of large H₂ PSAs as the production is increased by hundreds of Sm³/h, is obtained at a very low cost.

As the case may be, the process according to the invention can exhibit one or more of the following characteristics:
the gas stream represents less than 10% of the molar flow rate of the main gas stream and exhibits a hydrogen content of less than 15 mol %, more preferably of less than 5 mol %.
the secondary stream exhibits a hydrogen content of less than 1 mol %. At a constant amount of hydrogen at the inlet of the PSA, the feed gas mixture is thus simply “weighted” with chosen impurities.
the PSA employs at least one adsorber comprising an adsorbent or a group of adsorbents and the constituents of the secondary stream are not more adsorbable with regard to the adsorbent or the group of adsorbents used in the PSA than the constituents of the main gas stream. The constituents of the secondary stream are not more adsorbable with regard to the adsorbing materials used in the PSA than the constituents of the main gas mixture. Let us assume, for example, that the impurities in the main gas are nitrogen, methane and CO₂. The gas will preferentially be weighted in methane and/or in CO₂ rather, for example, than in heavy hydrocarbons, which risk being adsorbed too strongly on the adsorbents used, being poorly regenerated and resulting eventually in the reverse of the desired result.
the main gas stream has a hydrogen content of greater than 85 mol %, preferentially of greater than 90 mol %. The adsorber is in this case filled with hydrogen at the end of the adsorption stage and to weight the feedstock gas can make it possible to recover an additional fraction thereof cheaply. The solution provided is then to be compared with solutions of the type of recycling a portion of the waste product or with the use of a maximum of equilibrating stages. If a limited gain with regard to the hydrogen production flow rate is desired or if it is desired to minimize the capital cost, the solution provided in this instance may be the most advantageous.
the secondary stream consists, to more than 50 mol %, of methane, preferentially to more than 90 mol % of methane. Methane is a constituent which is moderately adsorbed, that is to say that, over activated carbon, for example, it is adsorbed less than CO₂ or nitrogen, these constituents being, with water, the most conventional impurities of H₂ PSA feeds. It is also adsorbed reversibly on the majority of zeolites. Methane will be able to be adsorbed, for example, on activated carbon virtually without interfering with the adsorption of CO₂ but while driving off hydrogen. The gas phase is also depleted in hydrogen as a result of the presence of methane.
the secondary stream consists, to more than 50 mol %, of CO₂, preferentially to more than 90 mol % of CO₂. This applies particularly to the H₂ PSAs treating a main gas mixture containing a few percent of CO₂, for example from 1 to 5 mol %. It is usual in this case to halt virtually all of this CO₂ on activated carbon. As above, this adsorbent will include a certain amount of hydrogen, whether in the adsorbed form or in the interstitial gas form. To increase the CO₂ content in the feed virtually does not modify the volume of adsorbent to be deployed but, as already explained above, this additional CO₂ will drive off hydrogen and make it possible to recover a small amount more thereof in the adsorption phase.
the secondary stream consists, to more than 50 mol %, of a mixture of CO₂ and methane, preferentially to more than 90 mol % of a mixture of CO₂ and methane. A mixture comprising these two gases in a large amount may be easier to find on site than a gas essentially composed of methane or carbon dioxide. Its effectiveness as additional stream can be as effective, indeed even more effective, than a stream essentially comprising one or other of these constituents.
the main gas stream is a stream resulting from a cryogenic separation unit, in particular from a hydrogen/carbon monoxide separation unit or from a refinery gas partial condensation unit.
said hydrogen/carbon monoxide cryogenic separation unit comprises an operation of washing with methane.
the secondary stream is essentially methane, preferentially withdrawn from the methane washing loop. It can also be a waste stream resulting from the cryogenic separation unit or natural gas. Other cryogenic units produce a gas fraction rich in hydrogen (with a purity generally of greater than 85 mol %) starting from an initial mixture comprising various hydrocarbons, hydrogen and optionally inert gases of nitrogen or argon type. Reference is then often made, in this case, to refinery gas or petrochemical gas. All or a fraction only of the stream enriched in hydrogen, often obtained by simple successive partial condensations of the feed gas until temperatures generally of between −130° C. and −180° C. are reached, is often purified of a portion of the residual impurities (Ar, N₂, CH₄ and the like) in a PSA in order to produce hydrogen at a purity of greater than 99.9 mol %. A secondary stream rich in methane can then be used to improve the yield.
the main gas stream is a synthesis gas, in particular a gas resulting from a steam reforming stage.
the secondary stream comprises more than 50 mol % of methane and is natural gas and/or preferentially a gas resulting from a stage of prereforming said natural gas.
the secondary stream flow rate is regulated as a function of the flow rate of the main gas stream and/or as a function of the content of a constituent in the main gas stream or in the main gas stream and secondary stream mixture. This makes it possible to keep unchanged the content of a feedstock gas, despite variations in flow rate.

The invention will now be explained by means of two examples relating to relatively different gases treated by PSA units operating on cycles which are also different.

### EXAMPLES

### Example 1

In the first example, a PSA unit which produces hydrogen of very high purity from a waste gas resulting from a hydrogen/carbon monoxide cryogenic separation unit, the mean composition of which is 98.3% H₂, 0.15% N₂, 0.5% CO, 1% CH₄ and 0.05% CO₂, at 22 bar and 40° C., is considered. The high pressure of the cycle is 22 bars abs. The low pressure of the cycle is 1.6 bar. The specifications of the top product are a minimum of 99.9% of H₂ but with a maximum of 10 ppm of CO, the latter constituent being found to be a poison for the downstream process using hydrogen. The adsorber is formed to approximately 20% of activated carbon and to 80% of molecular sieve.

Access can be had to a CH₄ source, available at a pressure at least equal to the pressure of the initial feedstock gas of the PSA, a small fraction of which source will be mixed with the feedstock gas at the inlet of the PSA in order to slightly weighten the feedstock gas of the H₂ PSA in methane.

In this example, the flow rate of waste gas rich in hydrogen resulting from the cryogenic separation unit is fixed, as is the very-high-purity hydrogen production flow rate to be provided. The standard yield of the PSA associated with this production flow rate is 86.5% in order to meet demand. The aim is thus to minimize the capital cost of the PSA while keeping a hydrogen yield at least equal to 86.5%. The cycle chosen in order to obtain this yield is a cycle having two equilibratings.

In a first step, the equilibrating stages are not modified, the cycle after addition of the methane remaining identical to the base cycle determined on the main feed alone. The differences in performance obtained as a function of the amount of CH₄ mixed with the feedstock gas are presented in table 1 below. Case 1 corresponds to the reference case (where more CH₄ is not added to the feedstock gas), for which the yield is 86.5%. Case 2 corresponds to the case where a further 2% as molar flow rate of CH₄ are added to the initial feedstock gas. Finally, case 3 corresponds to the case where a further 4% as molar flow rate of CH₄ are added to the initial feedstock gas. ΔVads, which is the increase in volume of adsorbent of the PSA necessary in order to obtain the purity required for the hydrogen, is revealed in this instance in the table. In practice, and in particular for case 2, there would be no reason to change the design of the PSA, the regulation with regard to the purity taking charge of reducing by a fraction of a second the duration of the adsorption stage, which would not have a secondary effect on the separation. In that way, a gain in yield Δη related to the addition of the methane to the initial feedstock gas is demonstrated. It should also be noted that the change in the performance qualities (Δη/ΔVads) is not linear as a function of the amount of methane injected. This comes from the fact that, for cases 1 and 2, it is the specification of 10 ppm maximum of CO which is determining with regard to obtaining the purity required for the hydrogen. In case 3, the nitrogen, which is adsorbed with difficulty, begins itself also to be forced out of the adsorbent and the methane itself to leave. It is the constraint related to the specification of 99.9% H₂ minimum which becomes determining and begins to require an increase in the volume of the beds of adsorbants, even if this increase is slight and has a virtually negligible effect on the overall capital cost of the PSA unit.

TABLE 1

| | Case | | |
|---|---|---|---|
| Perf. | 1 | 2 | 3 |
| Δη | ref. | +0.8 pt | +1 pt |
| ΔVads | ref. | +0.5% | +2.5% |

The gain with regard to the hydrogen production, of the order of 200 Sm³/h for a PSA producing 20 000 Sm³/h of hydrogen, is not negligible but it is not in this instance what is being looked for.

Consequently, in a second step, the number of equilibratings will be reduced for each of cases 2 and 3, so as to regain a yield of 86.5% while this time gaining in productivity. The new differences in performance obtained with respect to case 1 are presented in table 2. It is noticed that, for a given yield of 86.5% (Δη=0), that is to say in fact for a fixed hydrogen production, the fact of adding methane to the initial feedstock gas makes it possible to gain up to 22% less of volume of adsorbent to be installed (cf. change in ΔVads).

TABLE 2

| | Case | | |
|---|---|---|---|
| | 1 | 2′ | 3′ |
| Δη | ref. | +0 pt | +0 pt |
| ΔVads | ref. | −22% | −21% |

Such a gain in productivity may appear surprising as related to a variation of approximately 1 point in the yield (see table 1) but this is due in large part to the fact that the yield desired is particularly high for a gas of this type and that each additional point is difficult to obtain. By reasoning with regard to the losses of hydrogen in the waste product, it is seen that, on passing from case 3 to case 3′, an H₂ loss of 8% higher (loss of 12.5% changing to 13.5%) is allowed, which is no longer negligible seen from this angle.

Such an effect can be demonstrated experimentally, in particular on a pilot unit, by successively treating gases of different composition. This can be a validation stage before the application on an industrial unit. However, it is seen that the amount injected has to be precise and corresponds to a high-level optimization. The only truly industrial means of obtaining such results is to use software for the simulation of adsorption processes which are suited to PSAs. Such software now exists commercially and/or has been developed internally by companies working in the field of the separation of gases. With such tools, it is now possible to change step-by-step the amount of the secondary feed and to search automatically for an optimum with regard to criteria fixed beforehand by the user.

It would thus have been possible to test the effect of an injection of CO₂ in place of or in addition to methane, it being known that the PSA is already planned to halt that present in the main feed. Nevertheless, on the site envisaged, there is no available source of CO₂ under sufficient pressure and any compression unit, even for a small flow rate, adds an additional cost and an additional complexity which is not desirable. Conversely, there is/are generally one or more sources of methane or of gas very rich in methane (for example with a content of greater than 90 mol %) available at high pressure. Among these sources, mention may be made of natural gas, which is generally one of the starting materials used in the upstream units. This natural gas can undergo various pretreatments intended to remove possible impurities from it, such as sulfur-comprising products, traces of mercury, certain unsaturated hydrocarbons, cyclic compounds, and the like. The fraction constituting the secondary feed will be withdrawn at the most appropriate location, ordinarily after purification.

In the precise case of example 1, the H₂/CO cryogenic separation unit comprises an operation of washing with methane. The mixture feeding the cold box, namely essentially hydrogen and carbon monoxide also containing of the order of a percent or a few percent of nitrogen and methane, is cooled and then injected at the foot of a column fed at its top with a flow of subcooled liquid methane. On descending in the column, packed with plates or packing, the methane liquefies the CO, a large part of the nitrogen and the methane of the feed. The top of the column is hydrogen containing the residual nitrogen and carbon monoxide and also the amount of methane in equilibrium with the liquid phase which is, at this level, virtually pure methane. This content is of the order of a percent and varies little from one separation unit to another, the column top temperature being approximately—180° C. in order for the washing to be effective, while remaining slightly above the solidification point of methane. The washing methane circulates in the unit—using a pump which compresses it from the low to the high pressure—with an outlet via the hydrogen produced (approximately 1% of this flow rate) and an inlet via the feed gas. The inlet being very generally higher than the outlet, the excess methane is normally purged at low pressure. Provision is made in this instance to use the methane of the washing circuit after compression to the washing pressure as makeup constituting the secondary feed. This stream is then at the valid pressure to be injected directly into the main feed without requiring additional means. According to the organization of the line of heat exchanges between the heating fluids and the refrigerating fluids, the makeup can be injected at cryogenic temperature, for example in the form of liquid droplets, into the top fraction of the washing column or else after re-evaporation at ambient temperature. It may be possible to imagine operating the top of the washing column at a higher temperature, in order to directly have 2% or 3%, for example, of methane in the hydrogen stream, but this would be done, except in specific circumstances, to the detriment of the recovery of CO, whereas this is the main production of the cryogenic separation unit, or would complicate the upper part of the washing column.

From these alternative forms, it is seen at the injection of the secondary stream into the main feed gas may not be done at the actual inlet of the H₂ PSA but, for example, before a heat exchanger or a separator which are located on the main feed circuit. It is the fact of deliberately injecting a gas corresponding to the claimed characteristics in order to modify the composition of the feed of the PSA which matters and not the exact position of the injection, which can in particular be carried out further upstream if the process lends itself thereto.

### Example 2

The second example is that of a PSA unit which produces hydrogen of very high purity from a synthesis gas, itself already rich in hydrogen, but from which it is desired to extract certain impurities in a very high amount, such as N₂, CO, CH₄ and CO₂. In this case, it may also be advantageous, according to the composition of the synthesis gas, to increase the amount of CH₄ in the feedstock gas. This is because:
CH₄ is coadsorbed well with CO₂ on the activated carbon, and is coadsorbed well with CO and N₂ on the molecular sieve. It will thus take the place of the hydrogen on the activated carbon and the molecular sieve, while only weakly replacing the CO₂, CO and N₂ which it is desired to halt on these beds. It should be noted that this phenomenon, which means that there is after all little in the way of interactions between adsorbates (CO₂, CH₄ or CO, N₂, CH₄) is limited to composition ranges or more exactly partial pressure ranges of the different constituents. A very large methane content, corresponding to several bars of partial pressure, would have the consequence, in this case, of seriously interfering with the adsorption of CO, for example. It is seen that the optimization will be a question of proportioning the compositions.
The CH₄ specification in the top product is often relatively flexible. The methane is rarely the impurity which determines the design of the PSA. In many cases, it is thus possible to increase its content in the feed gas without fear of a sudden fall in the productivity, while taking into account the comment of the preceding paragraph. The main constraint is generally the content of CO, which is a poison for many catalysts, in particular hydrogenation catalysts. For “commercial” hydrogen, specifications requiring a minimum of 99.9% of H₂ and a maximum of 10 ppm of CO are typically found.

Likewise, it may be advantageous to increase the CO₂ content in the feedstock gas. This is because, by increasing the CO₂ content, the amount of H₂ coadsorbed on the activated carbon is decreased, which makes it possible to reduce the H₂ losses during the regeneration.

Generally, depending on the new composition of the feedstock gas after addition of certain compounds, it may be necessary to adjust the distribution of the adsorbents, indeed even to add a layer of a new adsorbent. Typically, if light hydrocarbons, ranging from ethylene to pentane, are added to the feedstock gas of a PSA, it is then necessary to install a layer of silica gel dedicated to halting them, upstream of the layer of activated carbon. Likewise, if the content of CO₂ is substantially increased in the feedstock gas of the PSA, it is then necessary to increase the proportions of activated carbon necessary to halt it.

More specifically, in this instance a PSA unit is considered which produces hydrogen from a synthesis gas resulting from steam reforming, the composition of which is 73.5% H₂, 0.5% N₂, 3% CO, 6.5% CH₄, 16% CO₂, at 25 bar and 40° C. The high pressure of the cycle is 25 bars. The low pressure of the cycle is 1.6 bar. The specifications of the top product are at least 99.9% of H₂ with a maximum of 100 ppm of N₂ and 10 ppm of CO. The adsorber is formed to 60% of activated carbon and to 40% of molecular sieve. The bed of activated carbon is designed in order to halt the CO₂, whereas the bed of molecular sieve is designed in order to halt the CO, the N₂ and the CH₄ not halted on the activated carbon, at the required specifications.

In this example, the aim is to enhance the hydrogen yield as much as possible in value, so as to produce as much hydrogen as possible at the required purity for a given flow rate of synthesis gas at the inlet. A cycle having four equilibrating stages is thus chosen.

As above, it is assumed that access is had to a CH₄ source, for example natural gas, available at a pressure at least equal to the pressure of the initial feedstock gas of the PSA, which is very generally the case as it is the starting material for synthesis gas; a fraction of this secondary stream is injected into the main feedstock gas of the PSA in order to slightly change the composition thereof by enriching it in CH₄.

The differences in performance in terms of hydrogen extraction yield (Δη) and of additional volume of adsorbant to be installed (ΔVads) which are obtained as a function of the amount of CH₄ mixed with the feedstock gas are presented in table 3 below. Case 1 corresponds to the reference case, where more CH₄ is not added to the feedstock gas. Case 2 corresponds to the case where a further 2% as molar flow rate of CH₄ are added to the initial feedstock gas. Finally, case 3 corresponds to the case where a further 4% as molar flow rate of CH₄ are added to the initial feedstock gas.

TABLE 3

| | Case | | |
|---|---|---|---|
| Perf. | 1 | 2 | 3 |
| Δη | ref. | +0.5 pt | +1 pt |
| ΔVads | ref. | +2.5% | +5% |

It is noticed that the addition of methane to the feedstock gas makes possible significant gains in yield, while the increase in the volume of adsorbants necessary to treat the new feedstock gas remains relatively low. In case 3, 1 point of yield is thus gained, for an installed volume of adsorbants only 5% higher. It should be noted that this increase in volume takes account both of the change in composition of the feedstock gas and of its increase in flow rate.

For each of the three cases simulated, the design of the bed of molecular sieve was restricted by the specification of 100 ppm of N₂. There was no change in the determining impurity between case 1, case 2 and case 3. This probably explains in part the virtually linear change in the performance qualities as a function of the amount of methane added, in contrast to the case of example 1.

The injection of methane was favored with respect to that of CO₂, not only because this first fraction is available under pressure but because such a natural gas fraction would have been injected in any case into the low pressure waste product of the H₂ PSA in order to increase the calorific value thereof, this waste gas being used as fuel in the process for the manufacture of the synthesis gas.

Used as rinse gas, that is to say after the adsorption stage, such a low flow rate of methane (or natural gas) would have only a negligible effect on the performance levels of the PSA, its effect being limited to the inlet zone of the PSA, whereas, as a mixture, it makes it possible to displace admittedly less hydrogen but in practice over the entire volume and not over a very thin layer of adsorbent.

The two preceding examples are based on a synthesis process starting from natural gas. This natural gas is generally subjected to various pretreatments before passing into the synthesis reactor proper. Throughout these treatments, it remains under pressure and can thus be withdrawn at the most appropriate point in order to act as secondary stream in the H₂ PSA.

Other gases or mixtures of gases, if they are available, might be used, provided that the simulations show the advantage of such an addition. In practice, mixtures of gases containing constituents which are too difficult to desorb will be avoided. A first approach consists in not using a mixture containing several percent of a constituent which would be more adsorbable than the constituents already present in the main feed. The water which may be present in the main feedstock gas is not taken into account in this rule, as it is a constituent apart which is very adsorbable on many materials and which it is desired to rapidly halt on a first layer of adsorbent which is often dedicated to it.

As a rule of thumb, the aim may be to increase the content of a constituent which, due to its partial pressure in the main feed and the choice of the adsorbents, lies in the Henry region, that is to say that its adsorption capacity on the adsorbent selected is then virtually proportional to its content in the gas. As long as the conditions are within this region, there is no need in theory for more adsorbent in order to halt the additional amount of impurity: if the amount of impurity is increased, for example by 15%, the adsorption capacity of this impurity will also increase by approximately 15%.

Nevertheless, it has been observed, on an industrial unit for the production of hydrogen by PSA starting from an H₂, CO, CH₄ and CO₂ mixture in which the hydrogen content was approximately 80 mol % and the CO₂ content was a little more than 10%, that to further add a substantial amount of CO₂ made it possible, here also, to produce more hydrogen, after simple adjusting of the PSA. A simulation proceeds in the same direction but the phenomena coming into play are more complex. The additional CO₂ drives off the hydrogen from the activated carbon but also a portion of the methane, which experiences an increase in its content in the second half of the adsorbent, itself also acting as displacer of the hydrogen, as in the preceding examples.

On this subject, it may be supposed that the effect described would be less substantial in the case of a PSA having multiple layers of adsorbents, that is to say deploying more than ₄ or 5 successive layers of different adsorbants, each well adapted to a specific constituent or even to a given partial pressure range and particularly selective with regard to this constituent. This is another way of optimizing a PSA for a well fixed feed. The disadvantage is that the multiplication of the layers complicates the filling, the various interfaces having to be really horizontal in order not to create imbalances in the adsorber. Such a highly optimized arrangement with regard to a composition can be counterproductive as the composition of the feedstock gas can vary as a function of the operating conditions of the upstream units. A constituent extending too far into the PSA, that is to say into a layer of adsorbent not provided for it, can be adsorbed too strongly and be difficult to regenerate. In the context of the invention, provision can easily be made to regulate flow rate with regard to the secondary stream so as to retain, over time, one and the same content in the overall feed, for example 10 mol % of methane, the content in the main feed varying from 5 to 8 mol %. In the catalytic reactor case, such variations are frequent and a beginning of run composition and an end of run composition varying by several percent are often given. A controlled injection of a secondary stream can make it possible to bring the two compositions closer or to choose a more favorable composition which it is then possible to obtain or at the very least to approach at the beginning and end of life of the catalyst.

It is thus seen that the principle of the invention, by its aspect of regulation of an overall composition, can be applied to adsorbers comprising a plurality of adsorbing layers which are optimized as a function of the change in the composition of the gas inside the adsorbent.

The invention is limited to the cases of H₂ PSAs in which a gas essentially containing impurities is injected with the aim of improving the performance qualities, which goes against what would appear to be indicated by simple common sense, which generally is in favor of the feed which is the richest possible in hydrogen. Beyond these applications, the teaching of this development is that, for a given PSA cycle and a typical feed (that is to say, resulting from a known process which is used time and time again, such as synthesis gas reactors, partial cryogenic condensations of refinery gas or of H₂/CO mixture, and the like), there exist compositions more or less favorable to the separation envisaged. The addition of a small amount of a second gas as described in the context of the invention is the solution selected in this instance but there may exist other means of slightly modifying the composition of a gas in order to render it eventually more optimum with respect to the PSA. The tendency will then be to leave more impurities in the gas than in current practice. In a cryogenic process in which a light gas (helium, hydrogen, carbon monoxide) is obtained by partial condensation of the other heavier constituents (that is to say, more easily condensable constituents), the temperature of the gas/liquid separation can thus be reheated by a few degrees. In that way, the gas obtained will contain more condensable constituents, for example from 6 to 8 mol % of methane in hydrogen instead of targeting from 3 to 4%. Likewise, it is possible to adjust the degree of conversion of a catalytic reactor by acting on the reaction temperature or the top composition of a column by acting on the reflux of said column. A person skilled in the art will henceforth have to check whether a simple modification of the upstream process, which may moreover result in a saving in capital cost or in energy, does not result in a saving with regard to the PSA located downstream.

Generally, this invention can apply to any type of H₂ PSA, in particular to processes employing N adsorbers or N groups of adsorbers, N being between 2 and 24, M of which are simultaneously in the adsorption phase, with M between 1 and N-1, and comprising P equilibratings, P being between 0 and 5. Group of adsorbers is understood to mean adsorbers operating completely in parallel. It is possible, for example, to use ₄ adsorbers in parallel, rather than to employ an adsorber with twice the diameter. There is no theoretical limit to the number of adsorbers of a PSA. The biggest units approach 20 adsorbers in service. Beyond this, it is probable that a good solution will be to install two units of 50% size.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-14. (canceled)

15. A process for the production of a gas stream with a hydrogen concentration equal to or greater than 99.9% utilizing a pressure swing adsorption unit with a main gas stream comprising at least 70 mol % of hydrogen, wherein a secondary stream, representing less than 20% of the molar flow rate of the main gas stream and having a hydrogen content of less than 25 mol %, is introduced into the main gas stream upstream of the PSA.

16. The process as claimed in claim 15, wherein the secondary stream represents less than 10% of the molar flow rate of the main gas stream and has a hydrogen content of less than 15 mol %.

17. The process as claimed in claim 15, wherein the secondary stream has a hydrogen content of less than 1 mol %.

18. The process as claimed in claim 15, wherein the pressure swing adsorption unit utilizes at least one adsorber, comprising an adsorbent or a group of adsorbents and the constituents of the secondary stream are not more adsorbable with regard to the adsorbent or the group of adsorbents used in the PSA than the constituents of the main gas stream.

19. The process as claimed in claim 15, wherein the main gas stream has a hydrogen content of greater than 85 mol.

20. The process as claimed in claim 15, wherein the secondary stream consists, to more than 50 mol %, of methane.

21. The process as claimed in claim 15, wherein the secondary stream consists, to more than 50 mol %, of CO₂.

22. The process as claimed in claim 15, wherein the secondary stream consists, to more than 50 mol %, of a mixture of CO₂ and methane.

23. The process as claimed in claim 15, wherein the main gas stream is a stream resulting from a cryogenic hydrogen/carbon monoxide separation unit or from a refinery gas partial condensation unit.

24. The process as claimed in claim 23, wherein the hydrogen/carbon monoxide cryogenic separation unit comprises an operation of washing with methane.

25. The process as claimed in claim 24, wherein the secondary stream is essentially methane withdrawn from the methane wash.

26. The process as claimed in claim 15, wherein the main gas stream is a synthesis gas.

27. The process as claimed in claim 26, wherein the secondary stream comprises more than 50 mol % of methane and is natural gas.

28. The process as claimed in claim 15, wherein the secondary stream flow rate is regulated as a function of the flow rate of the main gas stream and/or as a function of the content of a constituent in the main gas stream or in the main gas stream and secondary stream mixture.
